(19) United States
(12) Patent Application Publication
(10) Pub. No.: US 2012/0282377 A1
(43) Pub. Date: Nov. 8, 2012

(54) Methods and Formulations for Inhibiting Degradation of Photosensitive Sweeteners and Sweetener Enhancers

(76) Inventors: Mani Upreti, Dunwoody, GA (US); Indra Prakash, Alpharetta, GA (US); Grant Dubois, Roswell, GA (US); Ling Ma, Marietta, GA (US)

(21) Appl. No.: 13/465,919

(22) Filed: May 7, 2012

Related U.S. Application Data
(60) Provisional application No. 61/482,862, filed on May 5, 2011.

(51) Int. Cl. A23L 3/3517; B65D 81/30; A23L 2/44; A23L 1/236; A23L 2/60

(52) U.S. Cl. 426/107; 426/541; 426/392; 426/397; 426/546; 426/545

(57) ABSTRACT

Methods of inhibiting the degradation of a photosensitive sweetener or a sweetness enhancer in a food or beverage formulation, the method comprising adding a photodegradation-inhibiting amount of one or more antioxidants to the food or beverage formulation; and/or packaging the food or beverage formulation in a UV absorbing container are provided. Food or beverage formulations comprising an antioxidant and a photosensitive sweetener or sweetness enhancer, and/or that is packaged in a UV absorbing package or dark-colored package are also provided.

### CROSS REFERENCE TO RELATED APPLICATION

This application claims priority to U.S. Provisional Application No. 61/482,862, filed May 5, 2011.

### FIELD OF THE ART

The present invention relates to methods which inhibit the degradation of photosensitive sweeteners and sweetness enhancers contained in food and beverage formulations, as well as food and beverage formulations containing photosensitive sweeteners and sweetness enhancers which exhibit improved resistance to photodegradation.

### BACKGROUND

Food and beverage formulations need to be produced with stable ingredients, particularly when such formulations or products are subject to periods of shelf life. Degradation of food and beverage formulations can be caused by many factors such as temperature (heat), pH, light, and other factors. Ingredients that contribute to the flavor profile of a food or beverage formulation need to be particularly stable to maintain the desired flavor profile.

Monatin (2-amino-4-carboxy-4-hydroxy-5-(3-indolyl)-pentanoic acid or 4-hydroxy-4-(3-indolylmethyl)-glutamic acid) is a natural sweetener. Monatin contains two chiral centers and therefore has four potential isomeric configurations: R,R-; S,S-; R,S-; and S,R-monatin. Different stereoisomers have different sweetening characteristics. Amino et al. have reported that the sweetness intensity is dependent on the optical purity of each stereoisomer (U.S. Patent Publication No. 2005/0020508). Monatin is known to be photosensitive and to degrade to malodorous degradation products when exposed to UV light.

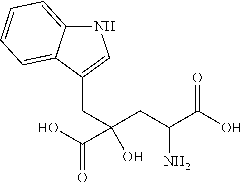

U.S. Pat. No. 7,781,005; U.S. Patent Publication No. 2012-0076899 and U.S. Patent Publication No. 2012-0041078 describe certain methods of minimizing photodegradation of sweeteners or sweetness enhancers.

Sweetness enhancers are compounds that enhance the sweetness of carbohydrate sweeteners or high potency sweeteners thereby allowing the formulation of foods, beverages and other sweet edible formulations with less sweetener compared to equally sweet formulations not containing a sweetness enhancer. The benefits of sweetness enhancers include a lower sweetener cost and in the case of caloric carbohydrate sweeteners, a lower calorie food, beverage or other sweet edible formulation that maintains the carbohydrate sweet taste profile. For example, a sucrose enhancer that enhances the sweetness of sucrose (sugar) twofold will allow the formulation of any sugar sweetened formulation with half the sugar while maintaining the taste profile and mouth feel of the fully sugar sweetened counterpart formulation.

The structure of 3-((4-amino-2,2-dioxido-1H-benzo[c][1,2,6]thiadiazin-5-yl)oxy)-2,2-dimethyl-N-propylpropanamide, a known sweetness enhancer, is shown below.

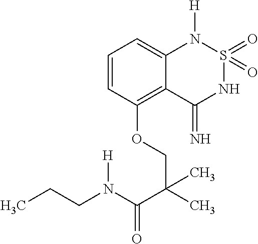

As with monatin, 3-((4-amino-2,2-dioxido-1H-benzo[c][1,2,6]thiadiazin-5-yl)oxy)-2,2-dimethyl-N-propylpropanamide is completely degraded to inactive ingredients upon exposure to sunlight for 2-3 days.

The utility of photosensitive sweeteners and sweetness enhancers would be greatly improved by the development of methods of slowing or inhibiting the UV-initiated degradation reactions of such compounds, including monatin and 3-((4-amino-2,2-dioxido-1H-benzo[c][1,2,6]thiadiazin-5-yl)oxy)-2,2-dimethyl-N-propylpropanamide. Accordingly, it is an object of the present invention to provide improved methods of inhibiting the photodegradation of photosensitive sweeteners and sweetness enhancers in food and beverages, including monatin and 3-((4-amino-2,2-dioxido-1H-benzo[c][1,2,6]thiadiazin-5-yl)oxy)-2,2-dimethyl-N-propylpropanamide. Improved food and beverage formulations containing photosensitive sweeteners and sweetness enhancers are also provided, which formulations exhibit improved resistant to photodegradation.

### SUMMARY OF THE INVENTION

Methods for inhibiting the degradation of photosensitive sweeteners and sweetness enhancers in a food or beverage formulation are provided herein, as well as food and beverage formulations containing photosensitive sweeteners and sweetness enhancers which formulations exhibit improved resistance to photodegradation. These photosensitive sweeteners and sweetness enhancers include, but are not limited to, monatin or 3-((4-amino-2,2-dioxido-1H-benzo[c][1,2,6]thiadiazin-5-yl)oxy)-2,2-dimethyl-N-propylpropanamide or salts thereof.

In one embodiment, the present invention is a method of inhibiting the degradation of photosensitive sweeteners and sweetness enhancers contained in food and beverage formulations by packaging these formulations in UV absorbing containers.

In another embodiment, the present invention is a method of inhibiting the degradation of photosensitive sweeteners and sweetness enhancers contained in food and beverage formulations by adding a photodegradation-inhibiting amount of one or more antioxidants to the food or beverage formulation.

In a further embodiment, the present invention is a method of inhibiting the degradation of photosensitive sweeteners and sweetness enhancers contained in food and beverage formulations by adding a photodegradation-inhibiting amount of one or more antioxidants to the food or beverage formulation and packaging these formulations in UV absorbing containers.

In a still further embodiment, the present invention is a food or beverage formulation containing photosensitive sweeteners and sweetness enhancers, which formulation exhibits improved resistance to photodegradation. In one particular embodiment, the food or beverage formulation contains a photosensitive sweetener and/or sweetness enhancer packaged in a UV absorbing container. In another particular embodiment, the food or beverage formulation contains a photosensitive sweetener and/or sweetness enhancer in combination with one or more antioxidants in an amount effective to inhibit degradation of the photosensitive sweetener and/or sweetness enhancer. In certain embodiments, the food or beverage formulation comprises an antioxidant and a photosensitive sweetener and/or or sweetener enhancer packaged in a UV absorbing container.

The UV absorbing container may vary. In one embodiment, the UV absorbing container is impregnated with one or more UV absorbing compounds. In another embodiment, the UV absorbing container includes a film, for example a dark-colored film, containing one or more UV absorbing compounds. In a further embodiment, the UV absorbing container is a colored or dark-colored container capable of absorbing UV light. In a particular embodiment, the UV absorbing container is a polyethylene terephthalate (PET) bottle that contains a UV absorbing compound.

The antioxidant or antioxidants may also vary. In one embodiment, the antioxidant is a food grade antioxidant. In one embodiment, the antioxidant in Chinese Green Tea Polyphenol. In another embodiment, the antioxidant is enzyme-modified isoquercitin (EMIQ). The antioxidants should be added in concentrations that do not impact the flavor profile or color of the food or beverage formulation.

### BRIEF DESCRIPTION OF FIGURES

FIG. 1 shows the UV scan data of PET bottles without a UV barrier (300 mL or 8 Oz), PET bottles with a UV barrier (600 mL or 16 Oz, fresh un-used bottle), and other PET bottles with a UV barrier (600 mL or 16 Oz, commercial packaging purchased from market).

FIGS. 2, 3 and 4 show HPLC/UV spectra of monatin degradation formulations.

### DESCRIPTION OF THE INVENTION

The present invention includes methods of inhibiting the degradation of photosensitive sweeteners and/or photosensitive sweetness enhancers contained in food and beverage formulations, as well as food and beverage formulations containing photosensitive sweeteners and/or sweetness enhancers which formulations exhibit improved resistance to degradation upon exposure to UV light. In certain embodiments, the photosensitive sweetener is monatin. In certain embodiments, the photosensitive sweetness enhancer is 3-((4-amino-2,2-dioxido-1H-benzo[c][1,2,6]thiadiazin-5-yl)oxy)-2,2-dimethyl-N-propylpropanamide.

In the case of monatin, photodegradation products minimized and in particular, photodegradation products having off flavors and or unpleasant odors are avoided. A particular photodegradation product of monatin is skatole or 3-methylindole, which has an unpleasant odor.

### I. Methods Utilizing UV Absorbing Containers

In one embodiment, a method of inhibiting the degradation of a photosensitive sweetener and/or or sweetness enhancer contained in a food or beverage formulation is provided, the method comprising packaging the food or beverage formulation in a UV absorbing container. UV absorbing containers, and the processes used to manufacture UV absorbing containers, are known. In certain embodiments, the photosensitive sweetener is monatin. In certain embodiments, the photosensitive sweetness enhancer is 3-((4-amino-2,2-dioxido-1H-benzo[c][1,2,6]thiadiazin-5-yl)oxy)-2,2-dimethyl-N-propylpropanamide.

In one embodiment, one or more UV absorbing compounds (also referred to as UV absorbers) are added to the raw materials used to make a container, such as, for example, a clear plastic beverage container, thereby incorporating the UV absorber into the container matrix, i.e., impregnating the container material. Alternatively, a film containing one or more UV absorbers can be made and provide a component of the container in order to absorb UV light. The film may be on the outside or inside of the container. For example, a UV absorbing film can cover or coat the container. Additionally, many dyes and pigments absorb UV light, such that colored beverage containers (e.g., amber- or dark-colored containers) can be employed to provide UV absorbance and inhibit degradation of the sweetener or sweetness enhancer.

The UV absorber can be any compound suitable for absorbing ultraviolet (UV) light. In a preferred embodiment, the UV absorber(s) absorb light in the wavelength range of from about 280 to about 390 nm, which covers both UVA and UVB light. Suitable UV absorbers include, but are not limited to, benzophenones and benzotriazoles. Preferably, food grade UV absorbers are employed when the food/beverage comes into contact with a surface of the packaging that contains a UV absorber incorporated therein. Suitable food grade UV absorbers include CRYSTALCLEAR PET UV Additive made by Ampacet Corp., Tarrytown, N.Y. 10591 and 2-(2′-hydroxy-3′-tert-butyl-5′-methylphenyl)-5-chlorobenzotriazole (Tinuvin 326™).

### II. Methods Utilizing Antioxidants

In another embodiment, a method of inhibiting the degradation of a photosensitive sweetener or sweetness enhancer in a food or beverage formulation is provided, the method comprising adding an effective photodegradation-inhibiting amount of one or more antioxidants to the food or beverage formulation. In certain embodiments, the photosensitive sweetener is monatin. In certain embodiments, the photosensitive sweetness enhancer is a photosensitive sweetness enhancer, for example 3-((4-amino-2,2-dioxido-1H-benzo[c][1,2,6]thiadiazin-5-yl)oxy)-2,2-dimethyl-N-propylpropanamide.

A variety of photostabilizer compounds, such as antioxidants, are used to inhibit the degradation of the photosensitive sweeteners and sweetness enhancers from light. A “photostabilizer” refers to a compound which can stabilize a sweetener or sweetness enhancer under light exposure. The light source can be artificial, such as ultraviolet (UV) lamp, or natural, such as sunlight. The photostabilizers or antioxidants described herein may exert their photostabilizing capability via a wide range of mechanisms.

Food or pharmaceutical grade antioxidants are added to the food and beverage formulations in amounts effective to inhibit the photodegradation of the sweetener or sweetness enhancer. The exact concentration or concentration range of an antioxidant can readily be determined by one of ordinary skill in the art by conducting routine photo stability experiments with various concentrations of antioxidants over a variety of pH, temperature and lighting conditions. Depending on the amount and/or concentration of the sweetener or sweetness enhancer in a given composition, the photostabilizer or antioxidant may be present in the composition in an amount ranging from about 10 ppm to about 500 ppm, about 50 ppm to about 300 ppm, or about 100 ppm to about 200 ppm. In one embodiment, a photodegradation-inhibiting amount of one or more antioxidants is added to the food or beverage formulation.

Any suitable antioxidant may be used to inhibit degradation of the sweetener or sweetness enhancer. Preferably, the antioxidants do not contribute any off flavors or off colors to the food or beverage. Suitable antioxidants include, but are not limited, to ascorbic acid, ascorbate, an ascorbic acid ester, erythorbic acid, erythorbic acid salt, an erythorbic acid ester, uric acid, bilirubin, albumin, astaxanthin, vitamin A, vitamin E, ubiquinol, a carotenoid, histidine, tryptophan, 2,6-di-tert-butyl-4-methylphenol, 2-tert-butyl-4-hydroxyanisole, 3-tert-butyl-4-hydroxyanisole, propyl gallate, catechin, enzyme-modified isoquercitin (EMIQ), rosemarinic acid, cichoric acid, ellagic acid, anthocyanins, phenol-containing compound, polyphenols, for example Chinese Green Tea Polyphenol, α-cyclodextrin, chromone derivatives, coumarine derivatives, a phenylpropenoic carbonyl compound, and mixtures thereof.

In one embodiment, the antioxidant used to stabilize or inhibit the photodegradation of the sweetener monatin and/or the sweetness enhancer 3-((4-amino-2,2-dioxido-1H-benzo[c][1,2,6]thiadiazin-5-yl)oxy)-2,2-dimethyl-N-propylpropanamide is enzyme-modified isoquercitin (EMIQ).

In another embodiment, the antioxidant used to stabilize or inhibit the photodegradation of the sweetener monatin or the sweetness enhancer 3-((4-amino-2,2-dioxido-1H-benzo[c][1,2,6]thiadiazin-5-yl)oxy)-2,2-dimethyl-N-propylpropanamide is a polyphenol, such as Chinese Green Tea Polyphenol.

In another embodiment, the antioxidant used to stabilize or inhibit the photodegradation of the sweetener monatin or the sweetness enhancer 3-((4-amino-2,2-dioxido-1H-benzo[c][1,2,6]thiadiazin-5-yl)oxy)-2,2-dimethyl-N-propylpropanamide is α-cyclodextrin.

In one embodiment, the antioxidant is a phenol-containing compound, for example a dihydrochalcone derivative, a flavanone derivative, a chromone derivative, a coumarine derivative, a phenylpropenoic carbonyl compound, a phenylpropanoic carbonyl compound, or a mixture thereof. In one embodiment, the phenol-containing compound is a naturally occurring compound and/or a substance that has been recognized by the Flavor and Extracts Manufacturers Association (FEMA) and is “Generally Regarded As Safe” (GRAS). A FEMA GRAS designation means that the substance receiving this classification has been tested using certain standards, and has been deemed safe for use by people.

In one embodiment, the antioxidant is a chromone derivative of the formula:

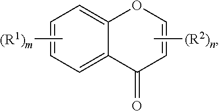

wherein:
m is 1, 2, 3, or 4;
n is 0, 1, or 2;
each R¹ and R² are independently —R^{a}, halo, —O⁻, ═O, —OR^{b}, —SR^{b}, —S⁻, ═S, —NR^{c}R^{c}, ═NR^{b}, ═N—OR^{b}, trihalomethyl, —CN, —OCN, —SCN, —NO, —NO₂, ═N₂, —N₃, —S(O)₂R^{b}, —S(O)₂NR^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)NR^{c}R^{c}, —NR^{b}C(NR^{b})R^{b}, or —NR^{b}C(NR^{b})NR^{c}R^{c}; and at least one of R¹ is —OH;
R^{a} is selected from the group consisting of a sugar ring, alkyl, substituted alkyl, cycloalkyl, substituted cycloalkyl, heteroalkyl, substituted heteroalkyl, cycloheteroalkyl, substituted cycloheteroalkyl, aryl, substituted aryl, arylalkyl, substituted arylalkyl, heteroaryl, substituted heteroaryl, heteroarylalkyl, and substituted heteroarylalkyl;
each R^{b} is independently hydrogen or R^{a}; and
each R^{c} is independently R^{b} or alternatively, the two les may be taken together with the nitrogen atom to which they are bonded form a 4-, 5-, 6- or 7-membered cycloheteroalkyl which may optionally include from 1 to 4 of the same or different additional heteroatoms selected from the group consisting of O, N and S.

In one embodiment, the antioxidant is a coumarine derivative of the formula:

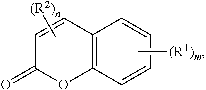

wherein:
m is 1, 2, 3, or 4;
n is 0, 1, or 2;
each R¹ and R² are independently —R^{a}, halo, —O⁻, ═O, —SR^{b}, —S⁻, ═S, ═NR^{b}, ═N—OR^{b}, trihalomethyl, —CN, —OCN, —SCN, —NO, —NO₂, N₂, —N₃, —S(O)₂R^{b}, —S(O)₂NR^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)NR^{c}R^{c}, —NR^{b}C(NR^{b})R^{b}, or —NR^{b}C(NR^{b})NR^{c}R^{c}; and at least one of R¹ is —OH;
R^{a} is selected from the group consisting of a sugar ring, alkyl, substituted alkyl, cycloalkyl, substituted cycloalkyl, heteroalkyl, substituted heteroalkyl, cycloheteroalkyl, substituted cycloheteroalkyl, aryl, substituted aryl, arylalkyl, substituted arylalkyl, heteroaryl, substituted heteroaryl, heteroarylalkyl, and substituted heteroarylalkyl;
each R^{b} is independently hydrogen or R^{a}; and
each R^{c} is independently R^{b} or alternatively, the two R^{c}s may be taken together with the nitrogen atom to which they are bonded form a 4-, 5-, 6- or 7-membered cycloheteroalkyl which may optionally include from 1 to 4 of the same or different additional heteroatoms selected from the group consisting of O, N and S.

In one embodiment, the antioxidant is a phenylpropenoic carbonyl compound of the formula:

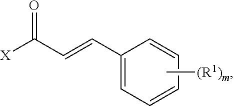

wherein:
m is 1, 2, 3, 4, or 5;
X is —R^{a}, —O⁻, —OR^{b}, —SR^{b}, —S⁻, —NR^{c}R^{c}, trihalomethyl, —OCN, —SCN, —OS(O)₂R^{b}, —OS(O)₂O⁻, —OS(O)₂OR^{b}, —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)NR^{c}R^{c}, —NR^{b}C(NR^{b})R^{b}, or —NR^{b}C(NR^{b})NR^{c}R^{c},
each R¹ is independently —R^{a}, halo, —O⁻, ═O, —OR^{b}, —SR^{b}, —S⁻, ═S, —NR^{c}R^{c}, ═NR^{b}, ═N—OR^{b}, trihalomethyl, —CN, —OCN, —SCN, —NO, —NO₂, ═N₂, —N₃, —S(O)₂R^{b}, —S(O)₂NR^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)NR^{c}R^{c}, —NR^{b}C(NR^{b})R^{b}, or —NR^{b}C(NR^{b})NR^{c}R^{c}; and at least one of R¹ is —OH;
R^{a} is selected from the group consisting of a sugar ring, alkyl, substituted alkyl, cycloalkyl, substituted cycloalkyl, heteroalkyl, substituted heteroalkyl, cycloheteroalkyl, substituted cycloheteroalkyl, aryl, substituted aryl, arylalkyl, substituted arylalkyl, heteroaryl, substituted heteroaryl, heteroarylalkyl, and substituted heteroarylalkyl;
each R^{b} is independently hydrogen or R^{a}; and
each R^{c} is independently R^{b} or alternatively, the two R^{c}s may be taken together with the nitrogen atom to which they are bonded form a 4-, 5-, 6- or 7-membered cycloheteroalkyl which may optionally include from 1 to 4 of the same or different additional heteroatoms selected from the group consisting of O, N and S.

In one embodiment, the antioxidant is a dihydrochalcone derivative of the formula:

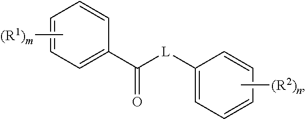

wherein:
L is an optionally substituted C1 to C4 alkylene;
m is 1, 2, 3, 4, or 5;
n is 0, 1, 2, 3, 4, or 5;
each R¹ and R² are independently —R^{a}, halo, —O⁻, ═O, —OR^{b}, —SR^{b}, —S⁻, ═S, —NR^{c}R^{c}, ═NR^{b}, ═N—OR^{b}, trihalomethyl, —CN, —OCN, —SCN, —NO, —NO₂, ═N₂, —N₃, —S(O)₂R^{b}, —S(O)₂NR^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)NR^{c}R^{c}, —NR^{b}C(NR^{b})R^{b}, or —NR^{b}C(NR^{b})NR^{c}R^{c}; and at least one of R¹ and R² is —OH;
R^{a} is selected from the group consisting of a sugar ring, alkyl, substituted alkyl, cycloalkyl, substituted cycloalkyl, heteroalkyl, substituted heteroalkyl, cycloheteroalkyl, substituted cycloheteroalkyl, aryl, substituted aryl, arylalkyl, substituted arylalkyl, heteroaryl, substituted heteroaryl, heteroarylalkyl, and substituted heteroarylalkyl;
each R^{b} is independently hydrogen or R^{a}; and
each R^{c} is independently R^{b} or alternatively, the two R^{c}s may be taken together with the nitrogen atom to which they are bonded form a 4-, 5-, 6- or 7-membered cycloheteroalkyl which may optionally include from 1 to 4 of the same or different additional heteroatoms selected from the group consisting of O, N and S.

In one embodiment, the antioxidant is a chromone derivative of the formula:

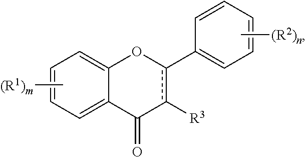

wherein:
m is 1, 2, 3, or 4;
n is 0, 1, 2, 3, 4, or 5;
each R¹, R², and R³ are independently —R^{a}, halo, —O⁻, ═O, —OR^{b}, —SR^{b}, —S⁻, ═S, —NR^{c}R^{c}, ═NR^{b}, ═N—OR^{b}, trihalomethyl, —CN, —OCN, —SCN, —NO, —NO₂, ═N₂, —N₃, —S(O)₂R^{b}, —S(O)₂NR^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)NR^{e}R^{e}, —NR^{b}C(NR^{b})R^{b}, or —NR^{b}C(NR^{b})NR^{c}R^{c}; and at least one of R¹ and R² is —OH;

R^{a} is selected from the group consisting of a sugar ring, alkyl, substituted alkyl, cycloalkyl, substituted cycloalkyl, heteroalkyl, substituted heteroalkyl, cycloheteroalkyl, substituted cycloheteroalkyl, aryl, substituted aryl, arylalkyl, substituted arylalkyl, heteroaryl, substituted heteroaryl, heteroarylalkyl, and substituted heteroarylalkyl;

each R^{b} is independently hydrogen or R^{a}; and
each R^{c} is independently R^{b} or alternatively, the two R^{c}s may be taken together with the nitrogen atom to which they are bonded form a 4-, 5-, 6- or 7-membered cycloheteroalkyl which may optionally include from 1 to 4 of the same or different additional heteroatoms selected from the group consisting of O, N and S.

In one embodiment, the phenol-containing compound is selected from the group consisting of cinnamic acid derivatives; flavones; isoflavones; chromones; coumarins; chalcones; and mixtures thereof.

In another embodiment, the phenol-containing compound is selected from the group consisting of caffeic acid, ferulic acid, sinapic acid, rosmarinic acid, chlorogenic acid, cichoric acid, caftaric acid, echinacoside, myricitrin, myricetin, apigenin, kaempferol, rhoifolin, luteolin, diosmin, apiin, morin, neodiosmin, quercetin, rutin, cupressuflavone, datiscetin, diosmetin, fisetin, galangin, gossypetin, geraldol, hinokiflavone, scutellarein, flavonol, primuletin, pratol, robinetin, quercetagetin, sinensetin, chrysoeriol, isorhamnetin, vitexin, isoquercitrin, daidzin, daidzein, biochamin A, prunetin, genistin, glycitein, glycitin, genistein, 6,7,4′-trihydroxyisoflavone, 7,3′,4′-trihydroxyisoflavone, chromone, visnagin, sophorachromone A, volkensiachromone, sawarachromone, mycochromone, 2-carboxyethenyl-5,7-dihydroxychromone, 7-hydroxy-5-(4-hydroxy-2-oxopentyl)-2-methylchromone-7-O-beta-D-glucopyranoside, 8-glucosyl-5,7-dihydroxy-2-(1-methylpropyl)chromone, diacromone, hymecromone, 5-hydroxy-2-methylchromone, cassiachromone, coumarin, coumestrol, dalbergin, daphnetin, esculetin, citropten, umbelliferone, scopoletin, xanthotoxol, psoralen, bergapten, fraxetin, butein, phloridzin, echinatin, marein, isoliquiritigenin, phloretin, polyhydroxychalcones, pholoretin, trilobtain, naringin dihydrochalcone, neohesperidin dihydrochalcone, naringenin, homoeriodictyol, hesperetin, myricitrin, enzymatically modified isoquercitrin (EMIQ), and a combination thereof.

### III. Combination Methods

In one embodiment, a method of inhibiting the degradation of a photosensitive sweetener or sweetness enhancer in a food or beverage formulation is provided, the method comprising packaging the food or beverage formulation in a UV absorbing container and optionally adding an effective degradation inhibiting amount of one or more antioxidants to the food or beverage formulation. In certain embodiments, the photosensitive sweetener is monatin. In certain embodiments, the photosensitive sweetness enhancer is a 3-((4-amino-2,2-dioxido-1H-benzo[c][1,2,6]thiadiazin-5-yl)oxy)-2,2-dimethyl-N-propylpropanamide.

### IV. Food or Beverage Formulations

The present invention also extends to food and beverage formulations containing photosensitive sweeteners or sweetness enhancers, which food and beverage formulations have improved photodegradation properties. In a particular embodiment, the photosensitive sweetener is monatin or a salt thereof In another embodiment, the photosensitive sweetness enhancer is 3-((4-amino-2,2-dioxido-1H-benzo[c][1,2,6]thiadiazin-5-yl)oxy)-2,2-dimethyl-N-propylpropanamide or a salt thereof.

In one embodiment, a food or beverage formulation is provided comprising a photosensitive sweetener and/or sweetness enhancer packaged in a UV absorbing container.

In another embodiment, a food or beverage formulation is provided comprising one or more antioxidants and a photosensitive sweetener and/or sweetness enhancer.

In another embodiment, a food or beverage formulation is provided comprising one or more antioxidants and a photosensitive sweetener and/or sweetness enhancer packaged in a UV absorbing container or dark-colored container.

In a particular embodiment, the UV absorbing package is a PET plastic bottle that contains a UV absorbing compound to prevent the degradation of a photosensitive sweetener or sweetness enhancer beverage contained in the bottle.

In one particular embodiment, the food or beverage formulation comprises sucrose and 3-((4-amino-2,2-dioxido-1H-benzo[c][1,2,6]thiadiazin-5-yl)oxy)-2,2-dimethyl-N-propylpropanamide and is packaged in a PET plastic bottle contains a UV absorbing compound. The formulation may also comprise antioxidants to provide additional protection to the 3-((4-amino-2,2-dioxido-1H-benzo[c][1,2,6]thiadiazin-5-yl)oxy)-2,2-dimethyl-N-propylpropanamide from degradation.

In one embodiment, the formulation is other than a food or beverage formulation, for example a pharmaceutical formulation. In one embodiment, the formulation is an edible or consumable formulation.

In any of the methods, or for any of the formulations described herein, the food or beverage containers can be any acceptable glass or plastic food container including clear plastic beverage bottles. A preferred food/beverage container is made from polyethylene terephthalate (sometimes written poly(ethylene terephthalate)), commonly abbreviated PET, PETE, or the obsolete PETP or PET-P. PET bottles are ubiquitous in the market place especially for use in packaging beverages, including soft drinks. PET beverage bottles containing one or more UV absorbers represent a preferred embodiment of the present invention. UV absorbing PET beverage bottles are made according to well known manufacturing processes. In certain embodiments, the UV absorbing package or UV absorbing PET beverage bottle absorbs UV light up to about 390 nm.

In one embodiment, the UV-absorbing container is for a formulation other a food or beverage formulation, for example a pharmaceutical formulation.

The UV absorbing PET bottle can be a colored PET bottle containing a dye or pigment that absorbs UVA and UVB light (280-390 nm wavelength) or a clear PET bottle that has one or more UV absorbers impregnated therein or contained in a film covering the PET bottle. In certain embodiments, the UV-absorbing PET bottle is dark-colored, for example light amber, dark amber, green, brown or black.

In one embodiment, the UV absorbing container is a dark-colored container, for example a dark-colored polyethylene terephthalate (PET) container. In one embodiment, the UV-absorbing container is a green-colored container. In one embodiment, the UV absorbing container is a polyethylene terephthalate (PET) container with a UV barrier. In another embodiment, the UV absorbing container comprises one or more UV absorbing compounds. In certain embodiments, the UV absorbing compounds comprise benzophenone. In one embodiment, the UV absorbing compounds comprise a benzotriazole compound. In one embodiment, the UV absorbing container is a container at least partially covered with a film impregnated with an effective UV absorbing amount of one or more UV absorbing compounds.

In one embodiment, the degradation of the sweetener or sweetness enhancer in a soft drink is inhibited by (a) packaging the soft drink in a UV absorbing PET bottle and (b) adding one or more antioxidants to the soft drink. In exemplary embodiments, the antioxidants can be any one or more food grade antioxidants that do not contribute any of flavors or off colors. The sweetener or sweetener enhancer, for example monatin or 3-((4-amino-2,2-dioxido-1H-benzo[c][1,2,6]thiadiazin-5-yl)oxy)-2,2-dimethyl-N-propylpropanamide, in the soft drink is stable under normal manufacturing, distribution and consumer use conditions typically retaining greater than 90%, 95% or 98% of the sweetener or sweetener enhancer.

In certain embodiments of the foregoing methods or formulations, the food or beverage formulation comprises one or more antioxidants. In one embodiment, the one or more antioxidants are selected from the group consisting of ascorbic acid, ascorbate, an ascorbic acid ester, erythorbic acid, erythorbic acid salt, an erythorbic acid ester, uric acid, bilirubin, albumin, astaxanthin, vitamin A, vitamin E, ubiquinol, a carotenoid, histidine, tryptophan, 2,6-di-tert-butyl-4-methylphenol, 2-tert-butyl-4-hydroxyanisole, 3-tert-butyl-4-hydroxyanisole, propyl gallate, catechin, enzyme-modified isoquercitin (EMIQ), rosemarinic acid, cichoric acid, ellagic acid, anthocyanins, or any other antioxidant described herein, and mixtures thereof. In a particular embodiment, the food or beverage formulation comprises the antioxidant enzyme-modified isoquercitin (EMIQ). In another embodiment, the food or beverage formulation comprises green tea extract or Chinese green tea polyphenol.

The following examples illustrate the practice of the present invention and should not be construed as limiting its scope.

### EXAMPLES

### Example 1

### Stability of Sweetness Enhancer 3-((4-amino-2,2-dioxido-1H-benzo[c][1,2,6]thiadiazin-5-yl)oxy)-2,2-dimethyl-N-propylpropanamide

Sweetness enhancer 3-((4-amino-2,2 -dioxido-1H-benzo [c][1,2,6]thiadiazin-5-yl)oxy)-2,2-dimethyl-N-propylpropanamide was evaluated for stability to sunlight exposure when formulated into a beverage packaged in PET packaging (bottle) with and without a UV barrier. The UV barrier PET bottle contained a UV absorbent compound that absorbs light up to approximately 390 nm. When a 25 mg/L solution of 3-((4-amino-2,2-dioxido-1H-benzo[c][1,2,6]thiadiazin-5-yl)oxy)-2,2-dimethyl-N-propylpropanamide was exposed to 395 Langleys of radiation (Atlas Sun Test XLS+Instrument) in a clear PET bottle with no UV barrier, 92% of 3-((4-amino-2,2 -dioxido-1H-benzo [c][1,2,6]thiadiazin-5-yl)oxy)-2,2-dimethyl-N-propylpropanamide was lost to degradation. The light exposure in this experiment was approximately equivalent to 24 hours of continuous irradiation or 2-3 days of normal sunlight irradiation (due to day/night cycle). In contrast, when the same experiment was carried out in a UV barrier PET bottle, only 10% of the 3-((4-amino-2,2-dioxido-1H-benzo[c][1,2,6]thiadiazin-5-yl)oxy)-2,2-dimethyl-N-propylpropanamide was lost to degradation.

### Example 2

### Stability Study of Monatin under Visible-Ultraviolet Light

High-potency sweetener monatin was evaluated for stability to sunlight exposure when formulated into a beverage packaged in PET packaging (bottle) with and without a UV barrier or in a dark-colored PET packaging. This study was designed to evaluate the stability of RR stereoisomer of monatin under normal visible light and under ultraviolet light in the Atlas sun-test chamber using normal PET bottles, PET packaging with a UV barrier and dark PET packaging. For this purpose monatin solution was made in a lemon lime carbonated beverage matrix without any flavor added.

### Beverage Formulation:

The RR isomer of monatin was used for the present study after satisfactory HPLC and LC-MS data analyses confirmed that this sample greater than 95% pure. A lemon lime beverage matrix without flavor was used as the matrix base. The concentration of monatin in the matrix was 30 ppm.

Due to lack of any RR-monatin standard, its stereoisomer, SS-monatin was used for HPLC calibration curve preparation as it appears at the same retention time as RR-monatin.

Quantitative analysis of monatin via UV detection in LC-MS was done for all the samples. The methodology employed a 12% acetonitrile (solvent A) in 50 mM ammonium formate (pH 4.0, solvent B) for 5 min followed by a linear gradient to 34% acetonitrile over 5 min; Detection: UV @278 nm].

### Packaging Materials:

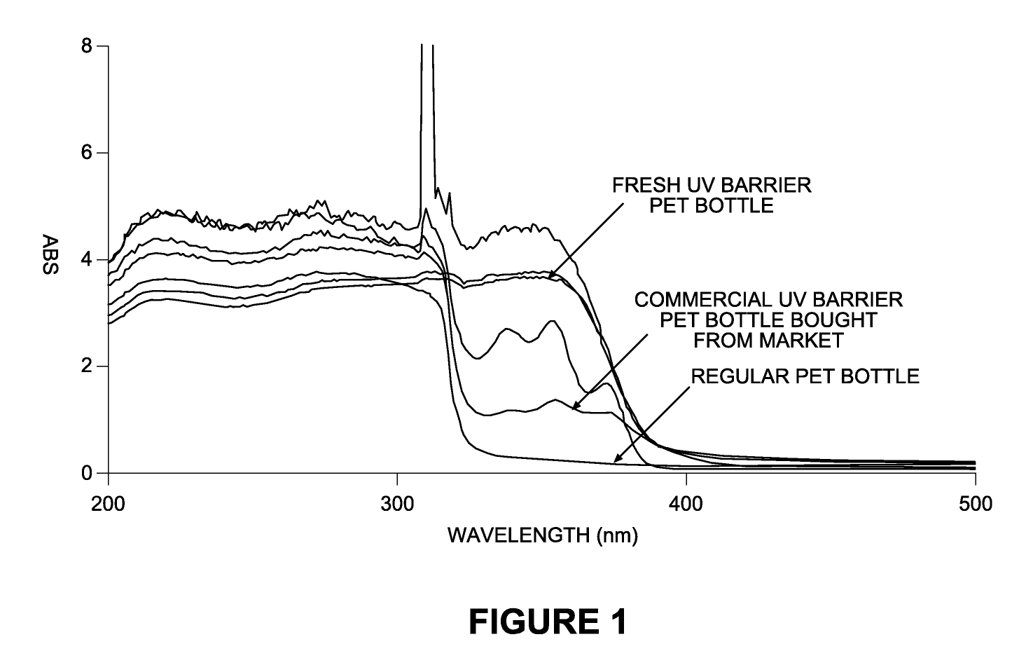

1) regular PET bottles, 300 mL or 8 Oz (bottle type A).
2) PET bottles with a UV barrier, 600 mL or 16 Oz, fresh un-used bottle* (bottle type B).
* It was shown that the UV barrier capacity decreased after one use in the commercially bought 20 Oz PET bottles with a UV barrier (See the UV scan data in FIG. 1).
3) dark-colored PET bottles (bottle type C).
UV light source: Atlas Sun-test chamber. Under program 1 of sun-test chamber, 6 hr of exposure is equal to one day of sun-light exposure in Arizona or 400 Langley at 40° C.
Control Experiment: UV irradiation by using only a lemon lime matrix (no monatin added) in regular PET bottles and running the sun-test chamber for four days equivalent exposure was carried out. The purpose of this experiment was to make sure no artifact arises from lemon lime matrix in the monatin absorption region. No new signals were identified.
13 bottles were used in the monatin-lemon-lime matrix experiments: 1 regular PET at zero time and 3 regular PET bottles; 2 PET bottles with a UV barrier bottles and 7 dark-colored PET bottles.
Zero time sample protocol: 330 mL PET bottle was filled up to ⅓^{rd} full, flushed with nitrogen, covered with foil and then kept at 4° C.
Sample aliquot protocol: 5 mL was taken out in a 20 mL opaque glass scintillation vial. Both vial and experimental bottle were flushed with nitrogen. The vial was covered with foil and kept at 4° C. Data was collected at specific time points, as detailed in Table 1.

TABLE 1

| | | bottle A | bottle A | bottle C | bottle C | bottle B | bottle B | Visible | | UV |
|---|---|---|---|---|---|---|---|---|---|---|
| Days | Time | visible | UV | visible | UV | visible | UV | time | | time |
| Tue | 8:15 AM | 1 | | | | | | zero | hr | |
| | 1:35 PM | 2 | | 3 | | 4 | | 5 | hr | |
| | 8.40 AM-2.40 PM | | 5 | | 6 | | 7 | | | 1 day eq. |
| | 4:15 PM | 8 | | 9 | | 10 | | 8 | hr | |
| | 3 PM-9 PM | | 11 | | 12 | | 13 | | | 2 day eq. |
| Wed | 10:00 AM | 14 | | 15 | | 16 | | 26 | hr | |
| | 8 AM-2 PM | | 17 | | 18 | | 19 | | | 3 day eq. |
| | 3:15 PM | 20 | | 21 | | 22 | | 31 | hr | |
| | 3 PM-9 PM | | 23 | | 24 | | 25 | | | 4 day eq. |
| Thu | 9:15 AM | 26 | | 27 | | 28 | | 49 | hr | |
| | 3:15 AM | 29 | | 30 | | 31 | | 55 | hr | |
| Fri | 10:00 AM | 32 | | 33 | | 34 | | 74 | hr | |

### Analytical Results:

LC-MS analysis was carried out on all the samples in the same day as their maturation. A new monatin calibration curve was made every day with the SS-monatin sample. From UV absorption the purity of SS-monatin was found to be 69% at 280 nm.

The quantitative results for sample exposed to visible light are shown in Table 2. For these experiments, visible light is the normal laboratory light which was left on all the time during the experiment. The results indicate that monatin in the lemon-lime matrix in any of the three types of bottles degrades less than 10% upon exposure to visible light for up to 74 hours.

TABLE 2

| | Conc. in mg/L | Conc. in mg/L | Conc. in mg/L |
|---|---|---|---|
| Hours | RR-Monatin in | RR-Monatin in | RR-Monatin in |
| in | Lemon Lime matrix | Lemon Lime matrix | Lemon Lime matrix |
| Visible | in Normal PET | in dark-colored PET | UV barrier PET |
| light | Bottle (330 mL) | Bottle (75 mL) | Bottle (600 mL) |
| 0 | 31.1 | 31.1 | 31.1 |
| 5 | 31.0 | 30.9 | 30.9 |
| 8 | 30.4 | 30.4 | 30.4 |
| 26 | 29.7 | 29.9 | 29.8 |
| 31 | 29.7 | 29.7 | 29.5 |
| 49 | 29.2 | 29.3 | 28.9 |
| 56 | 29.1 | 29.2 | 29.2 |
| 74 | 28.8 | 28.9 | 28.7 |

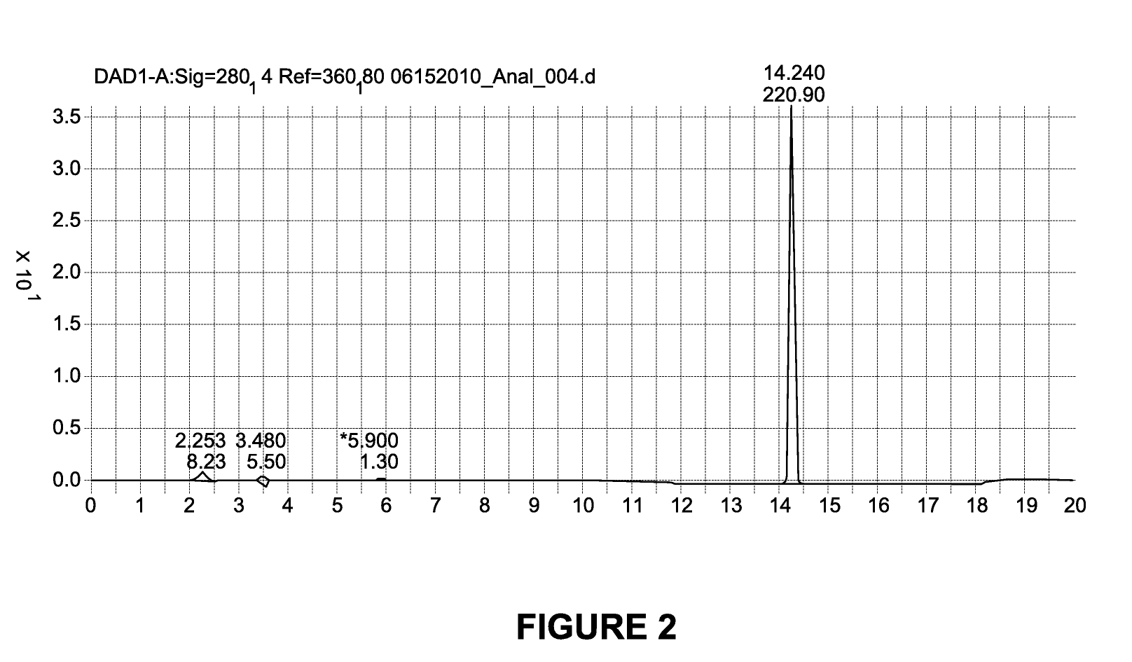

The quantitative results for sample exposed to ultraviolet light are shown in Table 3. For these experiments samples were kept in the Atlas sun-test chamber where each 6 hr exposure was equivalent to one day of sun exposure in Arizona (400 Langley). A photograph of the sample is presented in FIG. 2. The results indicate that, after four days equivalent of ultraviolet light exposure (24 hours in UV chamber), all of the monatin sample in the normal PET bottle had degraded, nearly 90% of the monatin sample in the UV barrier PET bottle had degraded, and less than 10% of the monatin sample in the dark-colored PET bottle degraded. In particular, it was noted that under UV light in regular PET, monatin degrades by 70% in just one day's exposure.

TABLE 3

| | | Conc. in mg/L | |
|---|---|---|---|
| | Conc. in mg/L | RR-Monatin in | Conc. in mg/L |
| Hours of | RR-Monatin in | Lemon Lime | RR-Monatin in |
| Exposure | Lemon Lime matrix | matrix in | Lemon Lime matrix |
| in UV | in Normal PET | dark-colored PET | in UV barrier PET |
| Chamber | Bottle (330 mL) | Bottle (75 mL) | Bottle (600 mL) |
| 0 | 31.1 | 31.1 | 31.1 |
| 6 | 9.0 | 29.2 | 27.6 |
| 12 | 2.1 | 29.1 | 22.4 |
| 18 | 0.3 | 29.0 | 9.8 |
| 24 | 0.0 | 28.6 | 3.6 |

A survey of odor and visual analysis of the UV and light exposed samples of the monatin samples was conducted by 6 panelists. Samples for analysis were solution of monatin in a lemon lime matrix without flavor at pH 3.35 (30 PPM monatin) exposed to visible for three days or UV light for 24 hours (equivalent of four days sun exposure). Panelist responses are shown in Tables 4 and 5.

TABLE 4
Panelists

| Sample No. | Sample type | 1 | 2 | 3 | 4 | 5 | 6 |
|---|---|---|---|---|---|---|---|
| 1 | Regular PET | + | + | + | + | + | + |
| | visible light | | | | | | |
| 2 | Regular PET | − | − | − | − | − | − |
| | UV light | Yellow- | Slight | Light | Yellow | | Pale |
| | | brown | yellow | yellow | | | yellow |
| 3 | PET with UV | + | + | + | + | + | + |
| | barrier visible light | | | | | | |
| 4 | PET with UV | − | − | − | − | − | − |
| | barrier | Yellow- | More | Faint | Yellow | | Slightly |
| | UV light | brown | yellow | yellow | | | yellow |
| 5 | Dark-colored PET | NA | NA | NA | NA | NA | NA |
| | bottle | | | | | | |
| | visible light | | | | | | |
| 6 | Dark-colored PET | NA | NA | NA | NA | NA | NA |
| | bottle | | | | | | |
| | UV light | | | | | | |

Visual analysis results: (+) = colorless; (−) = color change (color noted)

TABLE 5
Panelists

| Sample No. | Sample type | 1 | 2 | 3 | 4 | 5 | 6 |
|---|---|---|---|---|---|---|---|
| 1 | Regular | + | + | + | + | + | + |
| | PET visible | | | | | | |
| | light | | | | | | |
| 2 | Regular | − | − | − | − | + | − |
| | PET | High Skatole | Unpleasant | Unpleasant | Unpleasant | | Objectionable |
| | UV light | note | odor | odor | odor | | odor |
| 3 | PET with | + | + | + | + | + | + |
| | UV barrier | | | | | | |
| | visible | | | | | | |
| | light | | | | | | |
| 4 | PET with | − | − | − | − | + | + |
| | UV barrier | Mod. High | Unpleasant | Unpleasant | Unpleasant | | |
| | UV light | Skatole | odor | odor | odor | | |
| 5 | Dark- | − | + | + | + | + | + |
| | colored | Slightly dry - | | | | | |
| | PET bottle | plastic & | | | | | |
| | visible | slightly | | | | | |
| | light | animalic note | | | | | |
| 6 | Dark- | − | + | + | + | + | + |
| | colored | Very similar | | | | | |
| | PET bottle | to 5 above | | | | | |
| | UV light | but slightly | | | | | |
| | | more intense | | | | | |

Odor analysis results: (+) = no odor or minor odor; (−) = distinct or unpleasant odor

Generally, the results indicate that after UV exposure color and odor of the monatin-lemon lime matrix changes in both the regular PET bottle and PET with UV barrier bottle. Panelists noted no or minimal odor change after UV exposure of the samples in the dark-colored PET bottles.
Conclusion: Monatin in lemon-lime matrix was observed to degrade faster upon UV light exposure than upon visible light exposure. Regular PET bottles and PET with UV barrier bottles did not prevent degradation of monatin upon exposure to UV light. However, samples of the monatin solution in dark-colored PET bottles prevented most of the monatin from degrading.

### Example 4

### Monatin Stability in Beverage Formulation with Antioxidant

The polyphenol enzymatically-modified isoquercitrin (EMIQ) was used to stabilize monatin (31 mg/L) in a lemon lime carbonated beverage formulation contained in either a regular (clear, colorless) PET bottle or a dark-colored PET bottle. The level of EMIQ in the samples was 7.5 PPM. A control formulation was used that contained no EMIQ. The samples were exposed to UV light or ambient indoor laboratory fluorescent lighting for up to 72 hours. UV light was administered in a UV chamber at 40° C. with approximately 400 Langley per 6 hours of exposure. The results listed below indicate that the monatin was very unstable in the control formulations with only 1.4% monatin remaining after 24 hours exposure to UV light. EMIQ provided protection from degradation of the monatin. When packaged in a dark-colored PET bottle approximately 89% monatin remained in the formulation after exposure to UV light for 24 hours. When exposed to ambient indoor laboratory lighting for 72 hours over 90% monatin remained in both clear and dark PET bottles containing the EMIQ polyphenol. All analyses were done by HPLC/MS. Results are shown in Tables 6 and 7 below.

TABLE 6
Samples of monatin in lemon-lime matrix with
or without EMIQ exposed to UV irradiation

| | regular PET | | regular PET | | dark-colored PET | |
|---|---|---|---|---|---|---|
| | no EMIQ | | with EMIQ | | with EMIQ | |
| | Conc. of | | Conc. of | | Conc. of | |
| UV exp. | Monatin | % Monatin | Monatin | % Monatin | Monatin | % Monatin |
| (hours) | (mg/L) | remaining | (mg/L) | remaining | (mg/L) | remaining |
| 0 | 30.76 | 100 | 30.93 | 100 | 30.93 | 100 |
| 0 | 30.79 | 100 | 30.93 | 100 | 30.93 | 100 |
| 6 | 21.13 | 68.6 | 25.71 | 83.1 | 28.59 | 92.4 |
| 6 | 21.11 | 68.6 | 25.62 | 82.9 | 28.53 | 92.3 |
| 12 | 2.89 | 9.4 | 21.42 | 69.3 | 28.05 | 90.7 |
| 12 | 2.87 | 9.3 | 21.44 | 69.3 | 28.10 | 90.9 |
| 18 | 0.54 | 1.7 | 16.07 | 52.0 | 28.04 | 90.7 |
| 18 | 0.51 | 1.6 | 15.99 | 51.7 | 28.00 | 90.5 |
| 24 | 0.43 | 1.4 | 10.80 | 34.9 | 27.51 | 89.0 |
| 24 | 0.44 | 1.4 | 10.76 | 34.8 | 27.62 | 89.3 |

TABLE 7
Samples of monatin in lemon-lime matrix with EMIQ
exposed to visible light

| | regular PET | | dark-colored PET | |
|---|---|---|---|---|
| | with EMIQ | | with EMIQ | |
| | Conc. of | | Conc. of | |
| Vis. exp. | Monatin | % Monatin | Monatin | % Monatin |
| (hours) | (mg/L) | remaining | (mg/L) | remaining |
| 0 | 30.93 | 100 | 30.93 | 100 |
| 0 | 30.93 | 100 | 30.93 | 100 |
| 5 | 30.62 | 99.0 | 30.16 | 97.5 |
| 5 | 30.51 | 98.6 | 30.16 | 97.5 |
| 7 | 30.06 | 97.2 | 29.81 | 96.4 |
| 7 | 30.12 | 97.4 | 29.76 | 96.2 |
| 23 | 29.10 | 94.1 | 28.87 | 93.3 |
| 23 | 29.10 | 94.1 | 28.79 | 93.1 |
| 28 | 29.27 | 94.7 | 29.22 | 94.5 |
| 28 | 29.32 | 94.8 | 29.22 | 94.5 |
| 48 | 28.68 | 92.7 | 28.49 | 92.1 |
| 48 | 28.61 | 92.5 | 28.59 | 92.4 |

### Example 5

### Monatin Stability in Beverage Formulation with Antioxidant

The stability of monatin in regular PET bottles, PET bottles with UV barrier (colorless or green) and with or without Chinese Green Tea polyphenol or α-cyclodextrin was evaluated. Each sample was irradiated with an irradiation energy of 1600 Langley exposure (24 hour exposure at 40° C. in Atlas SunTest XLS+chamber, which was equivalent to four day of sun exposure in Arizona). A control formulation was used that contained monatin at 43.3 ppm. The results were analyzed by LC-MS. Results are shown in Table 8 below.

TABLE 8

| | | Monatin | Monatin |
|---|---|---|---|
| | | remaining | remaining |
| | | after UV | after UV |
| | | exposure | exposure |
| PET Bottle Type | Additives | (ppm) | (%) |
| Regular PET | none | 5.8 | 13.4 |
| PET with UV barrier | none | 22.1 | 51.0 |
| PET with UV barrier | Chinese Green Tea | 33.6 | 77.6 |
| | Polyphenol TP>40 | | |
| | (149 ppm) | | |
| PET with UV barrier | α-cyclodextrin | 14.4 | 33.3 |
| | (729 ppm) | | |
| Green PET with UV | none | 28.4 | 65.6 |
| barrier (0.12%) | | | |

### Example 6

### Sucrose Enhancer Stability in Beverage Formulation

The stability of sucrose enhancer 3-((4-amino-2,2-dioxido-1H-benzo[c][1,2,6]thiadiazin-5-yl)oxy)-2,2-dimethyl-N-propylpropanamide in regular PET bottles and PET bottles with UV barrier was evaluated. A control formulation was used that contained 106 mg sucrose enhancer in 4163 mg of a prototype beverage formulation. The prototype beverage formulation contained water, HFCS-55, citric acid, potassium citrate, EDTA, salts and vitamins. The samples were exposed to UV light using different Langley irradiation energy exposure at 40° C. in Atlas SunTest XLS+chamber. Results are shown in Table 9 below.

TABLE 9

| | | | Remaining | Loss of |
|---|---|---|---|---|
| | | Irradiation | Sucrose | Sucrose |
| | Bottle | Exposure | Enhancer | Enhancer |
| Sample | type | (Langley) | (ppm/%) | (%) |
| Blank | PET | 0 | 0 | 0 |
| Sucrose enhancer in | PET | 0 | 21.5/100% | 0% |
| prototype beverage | | | | |
| formulation (control) | | | | |
| Sucrose enhancer in | PET | 66 | 13.6/63% | 37% |
| prototype beverage | | | | |
| formulation | | | | |
| Sucrose enhancer in | PET with | 66 | 20.7/96% | 4% |
| prototype beverage | UV | | | |
| formulation | barrier | | | |
| Sucrose enhancer in | PET | 197 | 5.4/25% | 75% |
| prototype beverage | | | | |
| formulation | | | | |
| Sucrose enhancer in | PET with | 197 | 20.5/95% | 5% |
| prototype beverage | UV | | | |
| formulation | barrier | | | |
| Sucrose enhancer in | PET | 395 | 1.7/7.9% | 92% |
| prototype beverage | | | | |
| formulation | | | | |
| Sucrose enhancer in | PET with | 395 | 19.3/90% | 10% |
| prototype beverage | UV | | | |
| formulation | barrier | | | |

### Example 7

### Monatin Degradation Formulations

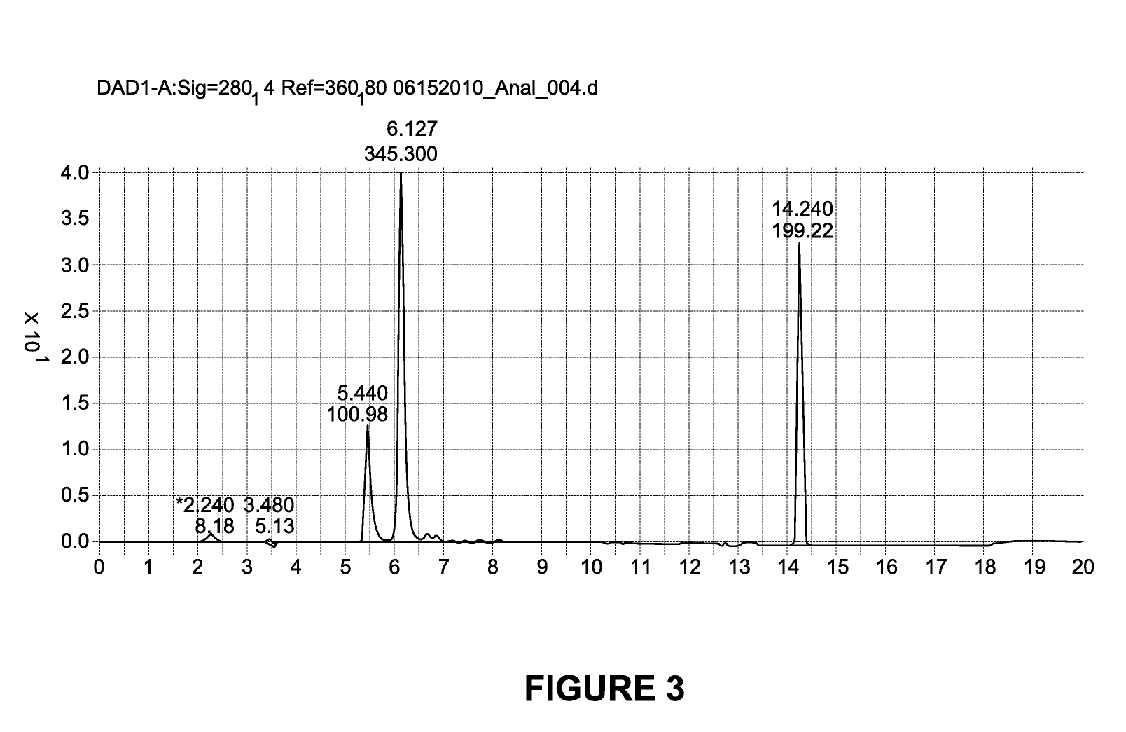

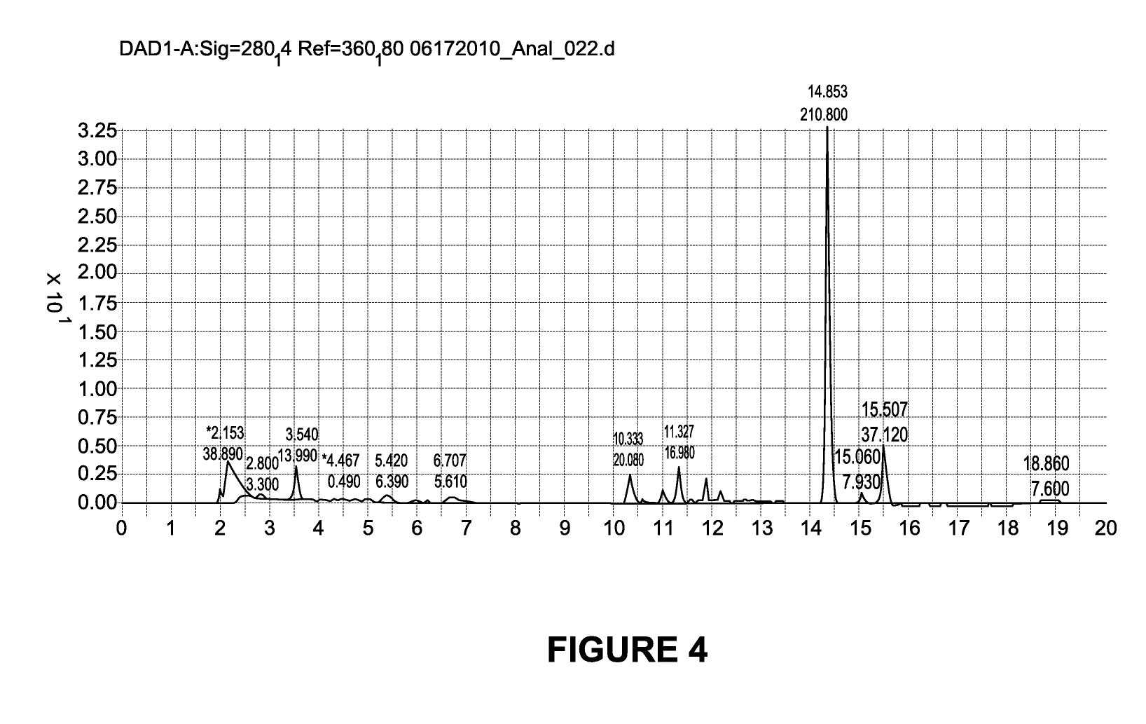

HPLC/UV was used to identify the degradation formulations of monatin. HPLC/UV spectra are shown in FIG. 3. Analysis was conducted on a base matrix (anal 004), monatin at time zero (Anal 010) and monatin after degradation (Anal 022) as shown below. The LC peaks were collected at 280 nm. Several degradants of monatin have been identified, including 2-hydroxy monatin, 2-amino-5-(1H-indol-3-yl)-4-oxopentanoic acid, a partial monatin dimer, indole-3-carboxylic acid, 3-formyl indole, monatin lactone, 2-(2-formamidophenyl)isonicotinic acid.

We claim:

1. A method of inhibiting the degradation of a photosensitive sweetener or sweetness enhancer in a food or beverage formulation, the method comprising packaging the food or beverage formulation in a UV absorbing container and/or adding a photodegradation-inhibiting amount of one or more antioxidants to the food or beverage formulation.

2. The method of claim 1, wherein the method comprises packaging the food or beverage formulation in a UV absorbing container.

3. The method of claim 1, wherein the method comprises adding a photodegradation-inhibiting amount of one or more antioxidants to the food or beverage formulation.

4. The method of claim 1, wherein the photosensitive sweetener is monatin.

5. The method of claim 1, wherein the photosensitive sweetness enhancer is 3-((4-amino-2,2-dioxido-1H-benzo[c][1,2,6]thiadiazin-5-yl)oxy)-2,2-dimethyl-N-propylpropanamide.

6. The method of claim 1, wherein the UV absorbing container is a polyethylene terephthalate (PET) container with a UV barrier.

7. The method of claim 6, wherein the container is green-colored.

8. The method of claim 6, wherein the container is brown-colored.

9. The method of claim 1, wherein the UV absorbing container comprises one or more UV absorbing compounds.

10. The method of claim 1, wherein the UV absorbing container is a container at least partially covered with a film impregnated with one or more UV absorbing compounds.

11. The method of claim 1, wherein the antioxidant is selected from the group consisting of ascorbic acid, ascorbate, an ascorbic acid ester, erythorbic acid, erythorbic acid salt, an erythorbic acid ester, uric acid, bilirubin, albumin, astaxanthin, vitamin A, vitamin E, ubiquinol, a carotenoid, histidine, tryptophan, 2,6-di-tert-butyl-4-methylphenol, 2-tert-butyl-4-hydroxyanisole, 3-tert-butyl-4-hydroxyanisole, propyl gallate, catechin, enzyme-modified isoquercitin (EMIQ), rosemarinic acid, cichoric acid, ellagic acid, anthocyanins, phenol-containing compound, polyphenols, Chinese Green Tea Polyphenol, α-cyclodextrin, chromone derivatives, coumarine derivatives, a phenylpropenoic carbonyl compound, and mixtures thereof.

12. The method of claim 11, wherein the antioxidant is Chinese Green Tea Polyphenol.

13. The method of claim 11, wherein the antioxidant is enzyme-modified isoquercitin (EMIQ).

14. A food or beverage formulation comprising an antioxidant and a photosensitive sweetener or sweetness enhancer, and/or that is packaged in a UV absorbing package or dark-colored package.

15. The formulation of claim 14, wherein the formulation is packaged in a UV absorbing container.

16. The formulation of claim 14, wherein the formulation comprises a photodegradation-inhibiting amount of one or more antioxidants.

17. The formulation of claim 14, wherein the photosensitive sweetener is monatin.

18. The formulation of claim 14, wherein the photosensitive sweetness enhancer is 3-((4-amino-2,2-dioxido-1H-benzo[c][1,2,6]thiadiazin-5-yl)oxy)-2,2-dimethyl-N-propylpropanamide.

19. The formulation of claim 14, wherein the UV absorbing container is a polyethylene terephthalate (PET) container with a UV barrier.

20. The formulation of claim 19, wherein the container is green-colored.

21. The formulation of claim 19, wherein the container is brown-colored.

22. The formulation of claim 19, wherein the UV absorbing container comprises one or more UV absorbing compounds.

23. The formulation of claim 14, wherein the UV absorbing container is a container at least partially covered with a film impregnated with one or more UV absorbing compounds.

24. The formulation of claim 14, wherein the antioxidant is selected from the group consisting of ascorbic acid, ascorbate, an ascorbic acid ester, erythorbic acid, erythorbic acid salt, an erythorbic acid ester, uric acid, bilirubin, albumin, astaxanthin, vitamin A, vitamin E, ubiquinol, a carotenoid, histidine, tryptophan, 2,6-di-tert-butyl-4-methylphenol, 2-tert-butyl-4-hydroxyanisole, 3-tert-butyl-4-hydroxyanisole, propyl gallate, catechin, enzyme-modified isoquercitin (EMIQ), rosemarinic acid, cichoric acid, ellagic acid, anthocyanins, phenol-containing compound, polyphenols, Chinese Green Tea Polyphenol, α-cyclodextrin, chromone derivatives, coumarine derivatives, a phenylpropenoic carbonyl compound, and mixtures thereof.

25. The formulation of claim 24, wherein the antioxidant is Chinese Green Tea Polyphenol.

26. The formulation of claim 24, wherein the antioxidant is enzyme-modified isoquercitin (EMIQ).
